(19) United States
(12) Patent Application Publication
(10) Pub. No.: US 2018/0169698 A1
(43) Pub. Date: Jun. 21, 2018

(54) PROCESS FOR SEALING, REINFORCING AND COSMETICALLY COATING CAST OR 3-D PRINTED GYPSUM ARTICLES

(71) Applicant: ZVERSE, Inc., Columbia, SC (US)

(72) Inventor: James W. KRONBERG, Aiken, SC (US)

(73) Assignee: ZVERSE ,INC., Columbia, SC (US)

(21) Appl. No.: 15/577,948

(22) PCT Filed: May 26, 2016
(86) PCT No.: PCT/US2016/034239

§ 371 Date: Nov. 29, 2017

Related U.S. Application Data
(60) Provisional application No. 62/169,314, filed on Jun. 1, 2015.

(51) Int. Cl. B05D 3/06; B05D 1/02; B05D 1/18; B05D 3/02; B05D 7/00; C09D 167/06

(52) U.S. Cl. CPC B05D 3/067; B05D 1/02; B05D 1/18; B33Y 80/00; B05D 7/577; C09D 167/06; B05D 3/0236

(57) ABSTRACT

A process for imparting improved toughness and durability, improving the surface appearance, and enhancing the coloration of a porous gypsum article created by 3D printing, casting or other means. The process includes the steps of first warming and drying the article; next, dipping it while warm into a bath of ultraviolet-activated liquid polyester resin at a lower temperature than the article, so the heat of the article lowers the resin's viscosity as air in the pores contracts and draws the resin in. The resin is chosen to have an index of refraction after curing as close as possible to that of pure gypsum. The resin is cured with ultraviolet light before applying a surface finishing coat to the cured resin by a second dipping into the same resin followed by curing or by spray-painting or other coating technique.

### TECHNOLOGICAL FIELD

The disclosure relates to casting and printing three-dimensional articles. More specifically, the disclosure relates to processes for casting and printing three-dimensional articles of gypsum.

### BACKGROUND

Calcium sulfate hemihydrate (CaSO4.1/2H2O) is commonly formed by thermal dehydration of calcium sulfate dehydrate (CaSO4.2H2O). Dehydration begins around 80° C., with conversion to the hemihydrate complete by 150° C. Further heating drives off the remaining water, forming relatively unreactive anhydrous calcium hydrate (CaSO4).

All three of these materials are considered nontoxic. All occur naturally as minerals in sedimentary, evaporite and hydrothermal deposits: CaSO4.2H2O as gypsum, called alabaster when fine-grained or selenite when its crystals are visible to the naked eye; CaSO4 as the somewhat less common anhydrite; and CaSO4.½H2O as the relatively rare basanite. Alabaster, which is translucent and easily carved and polished, is esteemed as an ornamental stone.

Any of these materials, or mixtures of them, may also be formed in a wide variety of industrial processes, typically as waste, for example in the desulfurization of flue gas. The hemihydrate, more often called plaster of Paris when in powdered form, is a common article of commerce.

Upon being mixed with water, the powdered hemihydrate incorporates it and recrystallizes, re-forming the original gypsum as an open, porous network of randomly-oriented, rod-shaped crystals commonly called “plaster” and more correctly termed “cast gypsum” since the hemihydrate has been converted to the more hydrated form. FIG. 1, adapted from a scanning electron microscope image, shows a network of such crystals with a bar 100 included to indicate scale. Shaded areas such as 102 indicate the gypsum crystals, while unshaded areas such as 104 represent the air-filled pores between shaded areas 102. Typical crystals average about 200 angstroms (one micron) in diameter by 5000 angstroms (20 microns) in length. The typical volume fraction occupied by the unshaded areas 104 runs between 30% and 50%, depending on the proportion of water added and the mixing conditions.

Gypsum is colorless and transparent throughout the visible spectrum of light and on into the near ultraviolet. Its refractive index, measured using the sodium “D line” (bright yellow, actually a doublet at 588.995 and 589.592 nanometers), ranges from 1.519 to 1.531 depending upon the crystal orientation, thus averaging about 1.525 for a randomly oriented specimen. Light transmission through a single crystal is typically 92% at the D line, falling to 90% at 365 nanometers in the near ultraviolet, with most losses due to reflection at the crystal surface.

Single gypsum crystals are potentially strong mechanically. Like graphite, however, gypsum is made up of sheets of atoms tightly bonded in two dimensions but adhering loosely together in the third dimension. Selenite is easily cleaved apart between these sheets (in the parlance of minerology, it is termed “sectile”) and the sheets themselves, while strong in tension, are easily bent. This makes even solid gypsum relatively soft with a hardness of 2 on the Mineral Order of Hardness scale, compared to the hardness of diamond at 10).

The combination of this inherent softness with the porosity of cast gypsum and the typically poor adhesion between crystals makes cast gypsum articles relatively weak and subject to damage, especially by abrasion. As a result, it is desirable to protect a cast gypsum article either with a permanent “skin” formed of some other material. For example, drywall is a construction material formed by casting gypsum between thick sheets of paper. Another example of a protective skin is made by infiltrating the surface layers with a binding compound such as cyanoacrylate glue (manufactured by 3D Systems' under the trademark COLORBOND/ZBOND 90). See, for example, U.S. Pat. Nos. 7,968,626 and 8,506,862 (Giller, et al.), which are incorporated by reference herein in their entirety.

The recently introduced technology of three-dimensional (hereafter, “3D”) ink-jet printing builds up an article of virtually any desired size and shape from successive, thin layers of plaster of Paris, with or without polymers or other modifiers. Examples of such plasters are so-called “build powder” such as those sold by 3D Systems under the product numbers ZP 130 and ZP 131. The layers are deposited with an aqueous binder which may or may not also contain dyes. The technology for applying the binder is similar to that used in ordinary, two-dimensional ink-jet printing on paper. See, for example, U.S. Pat. No. 6,610,429 (Bredt, et al.), which is hereby incorporated by reference.

In absorbing and reacting with water in the binder, the plaster re-forms porous gypsum in which any dye present is incorporated, thereby giving color to the network. Another layer of plaster is then deposited, more binder applied, and so forth, thus building up the aspect layer by layer. For economy, the interior of an aspect is typically left undyed.

While this technology permits color to be added directly to 3D-printed aspects during the printing process itself, the resulting aspects are soft and easily damaged while their surfaces look dull and chalky with colors, due to light scattering at the interfaces between gypsum crystals and air, often pale and unsaturated.

Far greater durability, and thus wider usefulness, can be achieved by using the cast gypsum article as a scaffold into which a second material phase, called an “infiltrant,” can be incorporated. The liquid infiltrant is allowed or forced to penetrate into the pores of the article, and there becomes a solid. The combination of the resulting solid matrix with the gypsum matrix yields a hybrid material, arguably a nanocomposite, combining the best properties of the constituents. If a small quantity of infiltrant remains on the gypsum surface, in hardening it may form a smooth, glossy surface. In addition, if the refractive index of the hardened infitrant is reasonably well matched to that of gypsum, light scattering is minimized and colors, where used, appear deeper and richer.

Many different infiltrants have been used with cast gypsum, long antedating the development of 3D printing. Historically, hot wax has often been applied to sculptural pieces of cast gypsum and, on cooling, produced surface hardening. Building upon this concept, Z Corp, a subsidiary of 3D Systems, has developed an infiltration wax sold under the trademark PARAPLAST for treating 3D gypsum articles.

Wax, unfortunately, softens and re-melts when heat is reapplied, and thus is ill-suited for most purposes not purely decorative. Models infiltrated with wax may also resist further treatments, such as the application of paint or gloss coatings, since few other materials adhere well to a waxed surface.

More recently, low-viscosity liquid plastic resins have begun to supplant the waxes as infiltrants for gypsum. The most widely used is liquid cyanoacrylate, most commonly ethyl-2-cyanoacrylate, the active ingredient in the adhesive sold under the trademark SUPERGLUE. Placing a small amount of this liquid on a gypsum article causes it to be drawn into the pores by capillary force. It then reacts chemically with water bonded or adsorbed on the gypsum crystal surfaces, setting into a tough, hard mass. Cyanoacrylate can be applied to gypsum or other porous article either by dipping, or by “drizzling” the liquid onto the surface of the article from a nozzle.

Cyanoacrylate, however, has serious drawbacks which limit its applicability as an infiltrant. These result from its very high reactivity, not only with moisture within a gypsum article, but with virtually any other surface containing adsorbed moisture (H2O) or exposed hydroxyl (—OH) groups, or even with moisture in the air. Contact with H2O or —OH triggers polymerization which is self-sustaining, causing rapid solidification often releasing large amounts of heat.

Cyanoacrylate thus readily bonds most materials, including human skin. Even its fumes are irritating to the eyes, throat and lungs since they react with any moist material, forming a typically white, dusty-looking coating. This is the same material which forms in forensics laboratories when cyanoacrylate is used to render fingerprints visible as the vapors react with oils and salt left behind by the fingers.

Even if kept in its original container, cyanoacrylate will progressively thicken and solidify once exposed even to normal levels of humidity in the air. Unless draconian measures are used to dry the air, therefore, this property severely limits its usability as a dipping bath. “Drizzling” avoids this problem, but requires fresh material for each application and wastes much of it.

Cyanoacrylate has the further drawback of often forming, through reaction with atmospheric or other moisture, that same white, dusty-looking coating on the surfaces of articles with which it has been infiltrated. It is often necessary, therefore, to coat such an article with a second, dissimilar material such as wax or a clear varnish, simply to hide this disfiguring coating or make it less evident.

Other materials which have been tried as infiltrants, and in some cases introduced as commercial products, are epoxy resin, polyester resin, shellac, urethane varnish, acrylic paint and glue, and even spray paints. All of these have drawbacks: either they have a short working lifetime (“pot life”) once mixed for application, they penetrate the gypsum unevenly or, due to solvent evaporation and the resulting contraction of the solids left behind, fail to close a sufficient fraction of the pores to give optimal strength and appearance.

In addition, it may be difficult to create a uniform, glossy finish coat on cast gypsum using a solvent-borne infiltrant since the solvent in later-applied coats may soften or dissolve the solids from earlier applications, allowing them to sink deeper into the article, making spray-painting such an article frustrating. Some of these difficulties may be overcome by extreme measure such as using a vacuum to remove air from the pore spaces of the gypsum article, then immersing the article in a liquid resin and allowing air pressure to force the resin into the pores. This requires a resin which will then cure throughout the thickness of the article, for example by exposure to heat in a forced-air oven. Alternatively, the resin may be polymerized by electron irradiation as described in U.S. Pat. No. 4,514,471 (Sugimoto et al.), which is hereby incorporated in its entirety by reference.

### SUMMARY OF THE DISCLOSURE

A present process for sealing 3D articles imparts improved toughness and durability, improved surface appearance, and enhanced coloration of the article made by 3D printing, casting or other means. The process comprises the steps of first warming and drying the aspect. Next, dipping it while warm into a bath of ultraviolet-activated liquid polyester resin at a lower temperature than the article, so the heat lowers the resin's viscosity while air in the pores contracts and draws it in, and with the resin being chosen to have an index of refraction after curing as close as possible to that of pure gypsum. Next, the resin is cured with ultraviolet light. Lastly, a surface finishing coat is applied to the foundation formed by the cured resin, forming the finishing coat preferably by a second dipping into the same resin followed by curing, or alternatively, by spray-painting or other decorative means.

It is an aspect of the present disclosure to give gypsum articles, created by 3D printing, casting or any other process, increased durability and enhanced appearance through infiltration, using a dipping process or otherwise, with a resin composition such that subsequent curing may be accomplished easily under nonhazardous conditions.

It is a further aspect of the present disclosure that such resin itself should be nonhazardous and, except when deliberately subjected to the curing conditions, have an extended pot life that does not require stringent protective measures.

It is another aspect of the disclosure that penetration of the resin into the pores of the gypsum is facilitated and does not use to vacuum pumps, chambers or related techniques, thus avoiding costs and pump-down delays.

It is a further aspect of the disclosure that the treated articles may then be given an attractive glossy appearance, if desired, by simple repetition of a part of the same process and using the same nonhazardous, long-pot-life resin.

It is an aspect of the disclosure that the stages of the treatment process be suitable for small scale, hand production, if desired, or alternatively for high-volume mechanized production, using the basic steps of the process for the same results.

It is another aspect of the disclosure to create a novel nanocomposite material, comprising cast gypsum having an open three-dimensional lattice or scaffold of gypsum crystals with its pores, at least in the surface layer of said lattice, occupied by cured resin.

An aspect of the disclosure is a process for sealing an article, that includes the steps of providing a polyester resin that is at a first temperature, heating an article to a second temperature higher than the first temperature, and then applying the polyester resin to the article, by immersion or spraying, while the article is at a temperature higher than the first temperature. The polyester resin on the article is then cured with ultraviolet light.

An aspect of the disclosure is that the article is made of gypsum by casting or 3D printing.

Another aspect of the disclosure is that the article is heated to a temperature is between 40° C. and 80° C.

An aspect of the disclosure is that the article has a refractive index and the polyester resin has a refractive index matching the refractive index of the article, and that the polyester resin is a blend of straight-chain, unsaturated polyester resins selected to have a refractive index matching that of the article.

An aspect of the disclosure is the blending of resins, wherein the blend is made by blending phthalic and maleic anhydrides to form a first mixture, condensing propylene glycol with this first mixture to form a first resin, blending phthalic and maleic anhydrides to form a second mixture and then condensing propylene glycol with said second mixture to form the second resin. The indices of refraction of the first and second resins are then measured and quantities of the two resins are combined to obtain an index of refraction of the polyester resin that matches the index of refraction of the article.

Another aspect of the disclosure is that a finishing coat is applied to the surface of the article, which finishing coat may be paint, enamel, or more polyester resin.

An aspect of the disclosure is that the ultraviolet light for curing the polyester resin is ultraviolet light (UV light), and ultraviolet A light (UVA light) which is that in the wavelength region 315-400 nm, and may be generated by gallium-nitride light-emitting diodes and, at other times, the polyester resin is illuminated, if at all, by yellow light-emitting diodes.

An aspect of the disclosure is a process for making an article by printing a 3D article of gypsum; filling a bath with ultraviolet-activated polyester resin; heating the 3D article to a temperature between 40° C. and 80° C., such as 60° C., and then dipping the 3D article, then dipping the heated 3D article into the ultraviolet-activated polyester resin and allowing the 3D article to cool in said ultraviolet-activated polyester resin. Then, the 3D article is exposed to ultraviolet light, and then a finishing coating is applied to the 3D article.

Another aspect of the disclosure is that the ultraviolet-activated polyester resin is maintained at a temperature below 40° C.

Another aspect of the disclosure is an article having a first layer, which can be made of paint, enamel or cured polyester resin, a second layer inside the first layer that comprises a three-dimensional lattice of gypsum crystals filed by cured polyester resin in the pores among the gypsum crystals; and a third layer inside the second layer that comprises a three-dimensional lattice of gypsum crystals with the pores between the gypsum crystals free of polyester resin.

It is an aspect of the disclosure that the cured polyester resin is a cured blend of polyester resins having a first index of refraction and the gypsum crystals of the 3D printed article have a second index of refraction, and wherein the cured blend of polyester resins is selected so the first index of refraction matches the second index of refraction.

### BRIEF DESCRIPTION OF THE DRAWINGS

FIG. 1 represents a three-dimensional lattice of microscopic gypsum crystals as typically formed on hydration of plaster of Paris (calcium sulfate hemihydrate);

FIGS. 2A and 2B represent the same lattice after treatment with FIG. 2A being a schematic view based on FIG. 1 plus cured resin and FIG. 2B being adapted from an optical microscope digital photograph, according to aspects of the disclosure;

FIG. 3 schematically illustrates the curing process of a polyester resin;

FIG. 4 illustrates the change in viscosity of a typical liquid polyester resin with temperature;

FIG. 5 illustrates prior art relevant to the optimal practice of the disclosure;

FIG. 6 illustrates the main principles of the disclosure of the form of a flow chart; and

FIG. 7 shows a decorative FIG. treated using the principles of the disclosure.

### DETAILED DESCRIPTION OF THE DISCLOSURE

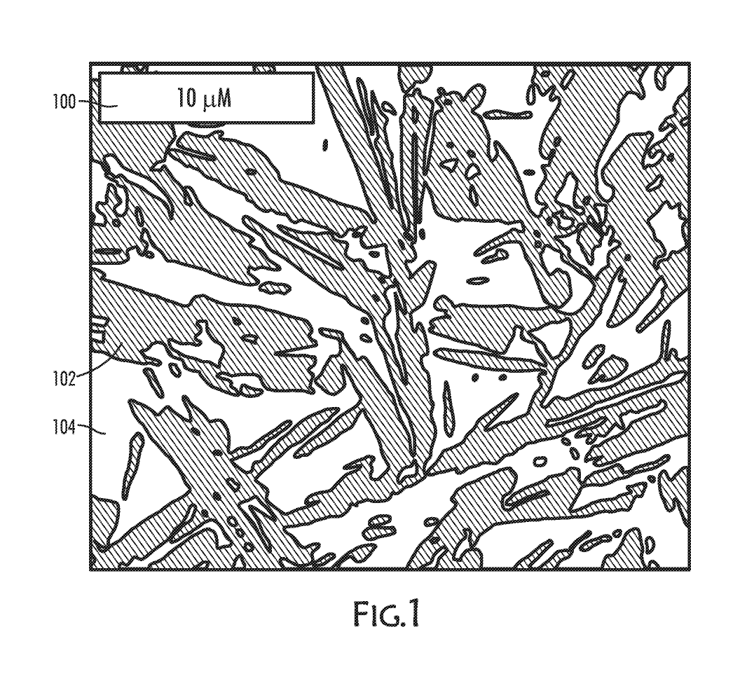

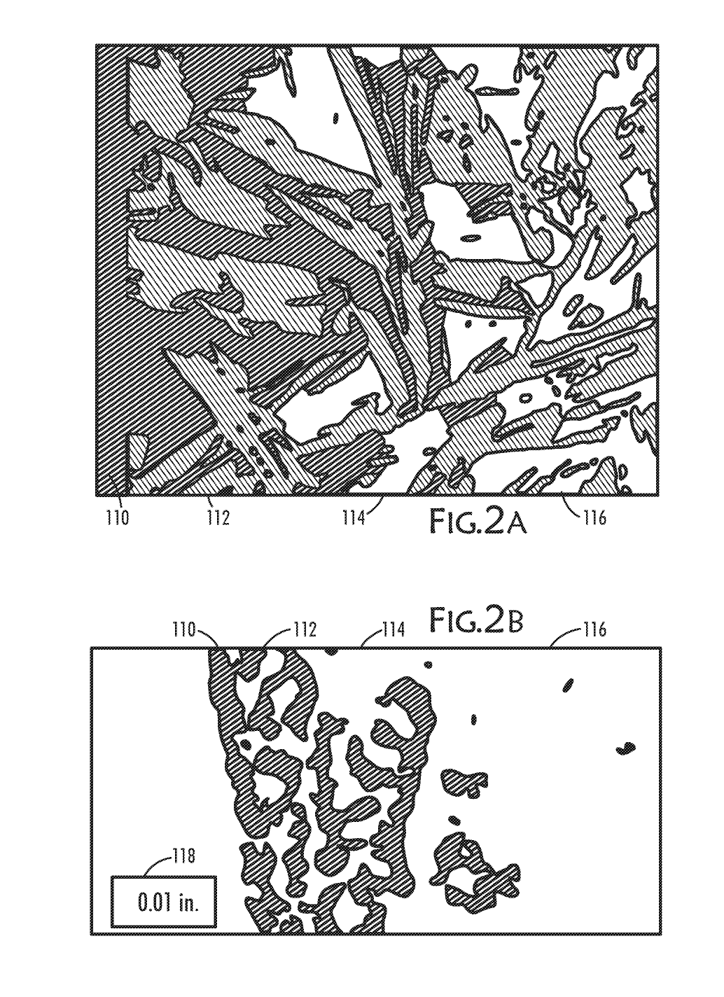

A treated cast gypsum article as schematically shown in partial cross-section in FIG. 2A, superimposed on the crystal lattice image from FIG. 1. The lattice includes a first layer 110 that is the outermost layer, made either of cured, polyester resin or of some other material such as paint; a second layer 112 comprising a portion of a three-dimensional lattice of rod-like gypsum crystals with cured polyester resin in its pores; a third layer 114 comprising a portion of the same said lattice whose pores are filled with a mixture of resin and air, and, finally, a core 116 comprising a portion of the same lattice with pores free of resin, or any successive combination of two or more of these layers including at least the second layer 112 and third layer 114, thus imparting an improved appearance and enhanced durability to the article and not adding cost or weight of 100% pore filling with resin. The durability of the article is further enhanced by the graded nature of junctions between layer second 112 and third layer 114 and between third layer 114 and core 116, if the latter is present, together with the presence of rod-like crystals extending across the junctions creating a mechanical interlock. FIG. 2B is adapted from an optical microscope digital photograph, and shows the same layers observed in an actual specimen treated using the principles of the disclosure and then sectioned for examination. Contrast in the photograph was enhanced, edges were sharpened for better black-and-white rendering, and a bar 118 was added to show the scale.

An occasionally used infiltrant for cast gypsum is liquid polyester resin. Polyester resin begins as a mixture of straight-chain, unsaturated polyester resins, such as the condensation products of propylene glycol with a blend of phthalic and maleic anhydrides. Unsaturated polyester resin chains typically have molecular weights between 1000 and 10,000. Monomeric styrene is then added as a reactive solvent to lower the viscosity and enable hardening or curing of the liquid resin, which is often aided by an accelerator (co-catalyst) such as cobalt octoate.

The liquid resin is stable so long as it is protected from heat, light and air. At the point of use, further polymerization is triggered by free-radical production and crosslinking of the chains with bridges of styrene, thereby converting the liquid resin into a tough, transparent solid as generally indicated in FIG. 3, which the progression of curing from left to right. In FIG. 3, thick bars 130 represent the unsaturated polyester resin chains, dots 132 represent unreacted styrene molecules, and thin bars 134 represent crosslinking bridges formed by reacting styrene.

To avoid premature curing of the liquid resin, a free-radical scavenger such as butylated hydroxytoluene (BHT) or hydroquinone is added as an inhibitor.

Curing is then brought about, when desired, in either of two ways. Catalyst-activated resins require the addition of a small amount of a liquid catalyst, typically methyl ethyl ketone peroxide (MEKP) plus a stabilizer such as dimethyl phthalate, termed a hardener. When mixed with the resin, and thus effectively separated from the stabilizer, the unstable MEKP decomposes to form free radicals. These react first with the inhibitor until it is used up, then proceed (if enough catalyst has been added) to harden the resin.

Polyester resins of this type are widely known since for craft purposes. Unfortunately MEKP itself is a hazardous substance, able to cause permanent damage, for example, if splashed into the eyes. In addition, once the resin has been mixed with hardener it will cure whether used or not, so any mixed resin which cannot be used promptly is lost to the process and becomes waste.

Less familiar to most people is UVActivated resin. Such a resin contains a photo initiator, such as benzoyl peroxide, which, on absorption of ultraviolet radiation (UV), breaks apart into free radicals thus triggering polymerization and hardening. A form of UVActivated resin has been used in 3D printing, in which an article is repeatedly lowered into liquid resin and successive layers photo-hardened on top of previous layers. The ultraviolet wavelengths typically used lie in the wavelength range known as “black light” or “UVA,” centered around 365 nanometers, just beyond the short-wave limit of human vision because this wavelength region is easily generated using commercially available mercury-vapor tubes or gallium-nitride light-emitting diodes, has enough energy per quantum to trigger photo initiation, yet is relatively harmless to human skin and eyes.

A striking advantage of UVActivated resin is the fact that, with a little care taken in its use, almost none of it need be wasted. Until it is actually exposed to ultraviolet light, its composition remains unchanged and no polymerization occurs. Resin not exposed can thus be recovered for use. On exposure, curing is rapid and complete in a few minutes. For production use, however, a typically longer exposure to artificial UVA would normally be preferred to eliminate variations from changing solar intensities at different times of the day or year or with changes in the weather.

A likely reason for the limited use of polyester resin as an infiltrant for gypsum articles is the high viscosity of most such resins. Even with styrene added, the resin is thick and syrupy, penetrating fine pores only with difficulty.

Styrene (vinyl benzene), as the simplest unsaturated aromatic hydrocarbon, represents the best available compromise as a reactive solvent between non-aromatic alkenes, such as butadiene, which are excessively volatile and pose a fire hazard, and the heavier aromatics, which are progressively even more viscous. Solvents, since they contain no reactive double bonds, cannot polymerize and must be removed instead by evaporation, causing shrinkage or leaving voids in the finished article and often giving it a lingering chemical odor as solvent continues to escape from the article's interior.

Warming the gypsum tends to drive out moisture from the surface layers, likely enhancing the bond which forms between the hydrophobic, water-insoluble resin and the gypsum. Further, warming expands the air within the pores so that, as the gypsum cools again as it will if immersed in room-temperature liquid resin while warm, the contraction of the air creates a partial vacuum further drawing the resin into the pores.

As yet another effect of warming, viscous liquids typically become more fluid with rising temperature so a warm body of gypsum will be infiltrated more easily by a viscous liquid than a cool one.

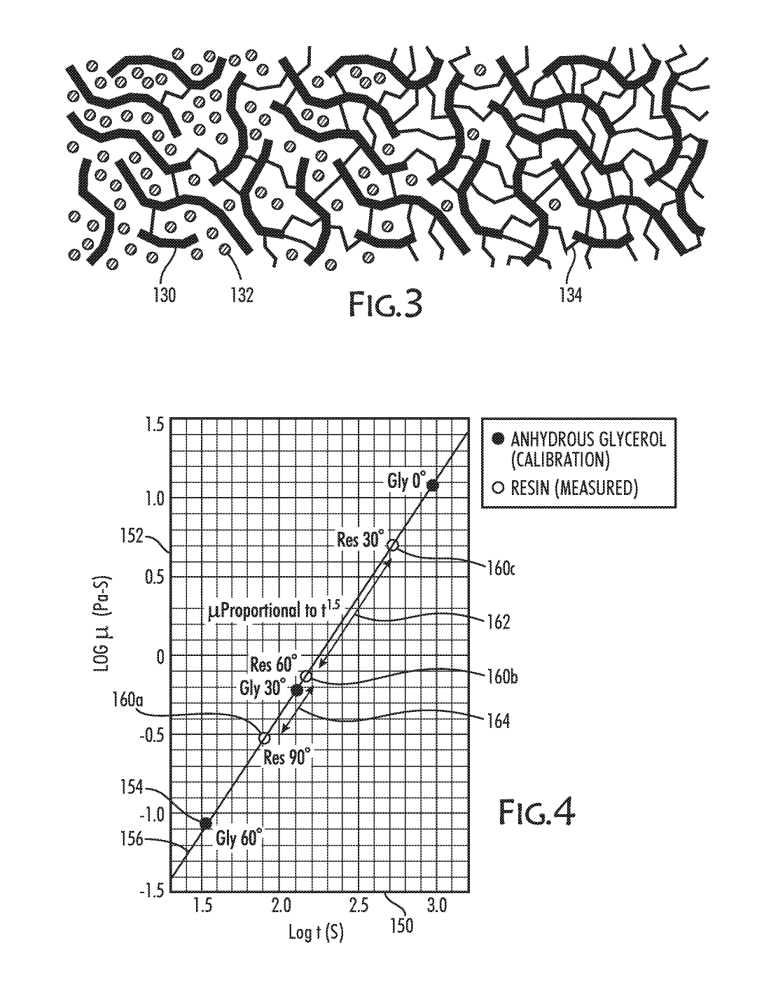

A falling-sphere viscometer, calibrated with anhydrous glycerol, was used to measure the change in resin viscosity with temperature as shown in FIG. 4. Horizontal and vertical scales 150 and 152, respectively, show the sphere's fall time through the calibrated part of the viscometer and the corresponding viscosity. Since both values vary over wide ranges with temperature, both scales are logarithmic. Black dots such as 154 are calibration points, and line 156 the calibration “curve” (in this case, the straight line representing a power law) drawn through them.

A sample of commercially available SUNFLASH resin had a viscosity of 4.9 pascal-seconds at 30° C., decreasing to 0.74 pascal-seconds at 60° C., then to 0.30 pascal-seconds at 90° C., as shown by open-circle data points 160a, 160b and 160c, respectively The expectation of resin viscosity decrease 162 (by a factor of 6.6) was confirmed with a modest temperature rise although the slightness of decrease 164 with a second, equally modest temperature rise (by only a factor of 2.5) came as a surprise. The relatively larger resin viscosity decrease 162 took place over the same temperature range which could best be used in preheating cast gypsum articles as previously described while not resulting in significant dehydration.

Once cured, the solid resin is no longer soluble in common organic solvents, including styrene. As a result, the first application of resin, once cured, forms an impermeable barrier layer at the surface of the cast gypsum article preventing later-applied coatings, including additional layers of the same liquid resin, from penetrating into the article. By keeping any such coating materials on the surface of the article, it thus forms an excellent base for paint or enamel. A tough, transparent, and glossy finish may be obtained by a second dipping in the same resin, if the temperature of the article is higher than the temperature of the resin.

By fortunate coincidence, the refractive indices of typical hardened polyester resins, as shown in FIG. 2 of U.S. Pat. No. 2,944,994 (Singleton et al.) which is hereby incorporated in its entirety by reference, lie in the range between 1.53 and 1.57 for the sodium-vapor D line, close to gypsum's at 1.525. While that patent was directed toward optical matching between the resin and reinforcing glass fibers forming a composite material for improved transparency, much the same relationship can be expected to exist between such resins and gypsum. The closer such a match, the more translucent the treated article becomes, and more nearly resembling natural alabaster and the darker and richer its colors appear for the same amount of ink present.

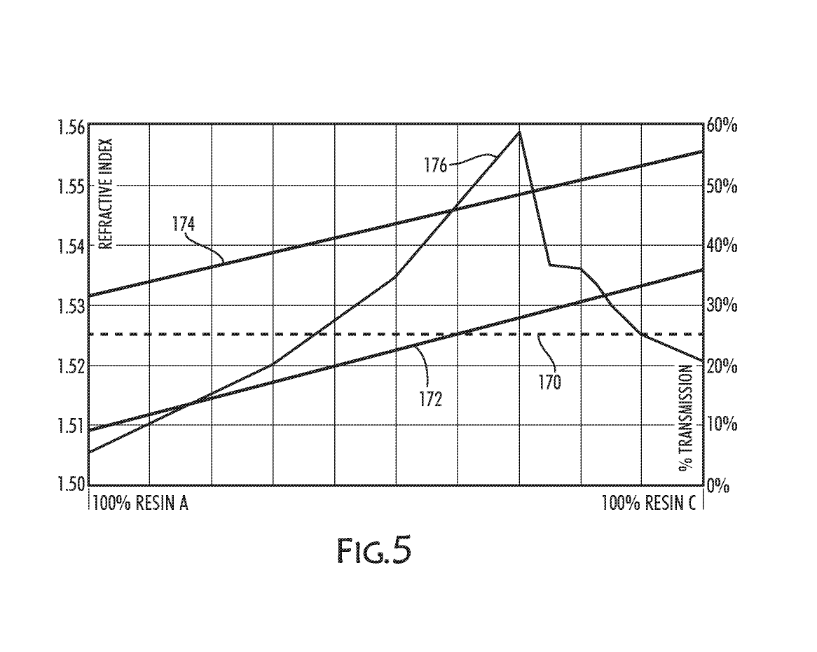

A tracing of FIG. 2 from the Singleton patent, unaltered save for the addition of reference characters and a horizontal line 170 representing the refractive index of gypsum, is reproduced as FIG. 5. Text shown in italics, including scale designations, is from the original figure. Straight diagonal line 172 shows the smooth change of refractive index in liquid resin between composition “A” derived from pure maleic anhydride and composition “C” in which 30% of the maleic anhydride on a per-mole basis was replaced by phthalic anhydride, while line 174 shows the same change in cured, solid resin. Peaked line 176 shows the effect of refractive-index matching yielding a maximum in transparency. The matching in this case is attributable to reinforcing glass fibers with a refractive index of about 1.55.

The principles explained in the Singleton patent, together with a modest amount of experimentation, improve the optical match with gypsum for purposes of the present disclosure. For example, that patent's described “Resin A” with a refractive index of 1.532, once cured, serve as the starting point from which a resin further optimized for refractive-index matching with gypsum could be formulated.

While polyester resins typically have significant ultraviolet absorption that increases with the presence of a photo initiator, gypsum itself is transparent to ultraviolet light in the range used with UVActivated resins. As shown again in FIG. 3, polyester resins typically increase in refractive index upon curing. Hence, a resin composition matched optically to gypsum's index of 1.52 after curing would have a significantly lower index when liquid, permitting total internal reflection of light within the gypsum crystals. The rod-shaped crystals themselves may thus act as light pipes allowing deeper penetration of ultraviolet light into the composite mass.

As was found by experimentation, the dyes commonly used in 3D printed gypsum articles are not soluble in liquid polyester resin to an extent causing any noticeable blurring of finely printed details in cast gypsum articles infiltrated with such resin if promptly cured by ultraviolet exposure.

The process sequence disclosed herein therefore comprises the following steps:

A resin bath is prepared by providing an open-topped vat or other container partially filled with a liquid UV-activated polyester resin. The dimensions of the container and depth of the resin in it are sufficient to allow total immersion of the cast gypsum article to be treated. The resin in the bath is held at a temperature between 10° C. and 40° C., preferably at ordinary room temperature around 25° C., and is protected from exposure to ultraviolet light. If ultraviolet light cannot be wholly excluded, the addition of a few percent of a liquid resin intended for catalyst curing while the catalyst is not present, will prolong the life of the bath although at the penalty of requiring longer exposure times.

An article, such as a decorative article illustrated in FIG. 5, formed of cast gypsum either by 3D printing using a gypsum-based build material or otherwise, is heated to a controlled temperature sufficient to drive out any water left unreacted from the initial printing or casting process or absorbed later, but not sufficient to cause dehydration of any gypsum already formed. The usable temperature range lies between about 40° C., slightly above room temperature and sufficient for removal of unreacted water, and about 80° C., at which the gypsum itself begins to undergo dehydration, such as a temperature of about 60° C. This heating step also expands the air in the void spaces of the cast gypsum material. Heating is preferably done using circulating air, for example, in a convection oven.

While hot, the article is quickly and fully immersed in the resin bath for a sufficient time to let cooling and capillary action draw the resin (made more fluid by the heat) deeply into surface pores. Penetration throughout the article is neither necessary, nor even desirable in most cases due to the cost of the extra resin that would be required. Experiments have shown that complete filling of the pores in an outer layer only a few thousandths of an inch thick is adequate at least for decorative and lightly-used articles, such as figurines, and that with a room-temperature (25° C.) resin bath and a small cast gypsum article at 60° C., this takes place within five to ten seconds. Larger articles may require slightly longer. Optimal times for articles of various sizes can be established through a modest degree of experimentation.

The article is then removed from the resin, and excess resin remaining on its surface is shaken off, allowed to drip off, blotted away or removed by other means. For example, in large-scale production an air blast or “air knife” may be preferable while in smaller-scale production simple hand blotting with a paper towel may be more practical. Thorough removal of excess resin at this stage will minimize or eliminate the need for finishing steps at the end.

When practical, heating and immersion steps should be performed under a safelight or other light source free from significant ultraviolet light, and under good ventilation. For example, a yellow LED light bulb normally produces no ultraviolet light at all. Other light sources, such as incandescent or compact fluorescent bulbs, may also be used provided any ultraviolet they produce is removed by filtering.

As an alternative to steps of heating, immersion, and removal of excess, where an article to be treated is of relatively simple geometry and does not have large recesses, such as a decorative plaque or 3D photograph, it may prove feasible to apply the resin by spraying rather than by dipping. This approach would likely not be feasible on a 3D printed article of complex shape due to failure of the spray to reach the depths of its recesses. Since the main intent of the disclosure is the treatment of just such complex shapes, therefore, application of the resin by dipping is preferred.

The article is illuminated with ultraviolet light sufficiently long to fully cure the resin. This strengthens the surface layer of the gypsum and creates a foundation for the finish coat to come. Illumination may be provided by ordinary daylight, but is preferably by “black light” or “UVA” of approximately 365 nanometers, produced by suitably filtered mercury-vapor tubes or, more preferably, by gallium-nitride light-emitting diodes. During illumination the article may be supported by one or more mechanical elements such as rods or wires, spaced apart or otherwise disposed so as to permit illumination of the article, and covered in a non-stick, non-reactive material such as polytetrafluoroethylene (PTFE) which is sold under the trademark TEFLON by DuPont; fluorinated ethylene propylene (FEP) which is sold under the trademark TEFLON FEP by DuPont may also be suitable.

The article is re-dipped in the resin, excess resin is removed, and the resin is solidified by UV exposure as before. The article does not have to be reheated for re-dipping. Alternatively, if a nontransparent or nonglossy finish is desired the article may be sprayed or otherwise coated with a suitable paint or enamel. The layer of resin-infiltrated gypsum created in the previous steps prevents later-applied paint or resin from soaking into the base material, and thus yields a smoother and more even finish coat.

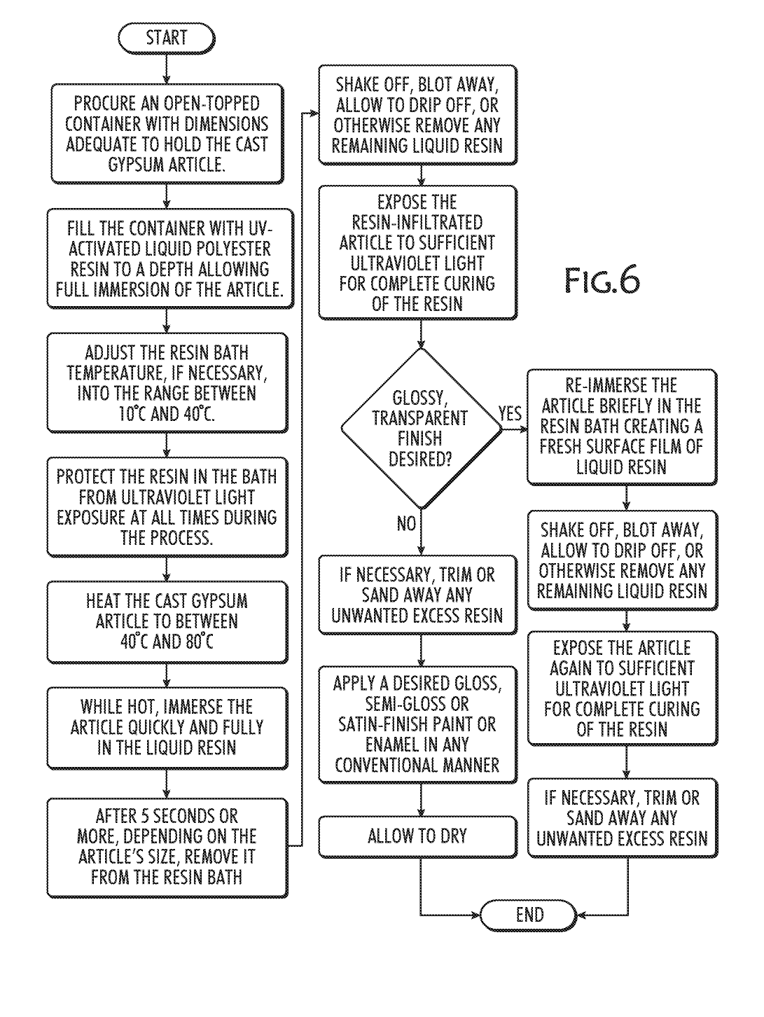

These steps are shown, slightly abbreviated and simplified, in FIG. 6 in the form of a flow chart. The resulting surface structure is multilayered, as was shown in FIG. 2A and FIG. 2B, with the second-outermost layer comprised of a gypsum scaffold whose pores are filled with hardened polyester resin. Tests show this composition of matter, a nanocomposite material, to be surprisingly hard, tough and difficult to break even in thin layers, approximating the strength of the pure resin itself. The decision block “‘Glossy, transparent finish desired?” at center of the article then permits either (if “yes” in FIG. 6) a finish coat of the same composition as the infiltrant, or (if “no”) another type of surface finish to be applied as the outermost layer.

### Example 1

A decorative article, namely, a football mascot dressed as Santa with a block C on its chest and holding a wrapped gift, was treated as follows. On the article as originally provided the Santa suit was not red but pink, presumably the most saturated color directly available from the printing process, and the article had a decidedly dull, almost chalky-looking surface finish.

The Santa article was saw-cut into nine pieces with some of the pink outer surface, along with some white base material, appearing on the pieces.

“Pure R” in the following Table 1 indicates pure UV-Activated resin, such as that distributed under the trademark SUNFLASH by Steve Meade Designs and sold on-line at www.amazon.com. An “80-20 mix” indicates a mixture of 80% UVActivated resin by volume with 20% catalyst-activated polyester resin, sold under the trademark CASTIN′ CRAFT, on-line at www.createforless.com, but with no catalyst actually added. Experiments showed that even small additions of the resin intended for catalyst activation sharply reduced the mixture's sensitivity to ultraviolet light: potentially prolonging the life of a resin bath under conditions in which not all ultraviolet light could be excluded, although at the cost of a longer curing time. With more than 20% catalyst-activated resin, ultraviolet curing times became impractically long and a complete cure was not always possible. Incomplete curing of a polyester resin is obvious due to the lingering, unpleasant odor of unreacted styrene.

“Preheat” in Table 1 indicates the temperature of the cast gypsum just prior to resin immersion. Articles were placed in a laboratory oven for ten minutes to reach equilibrium at the designated temperature, either 60° C. or 90° C. “DIP” indicates the articles were treated as shown in FIG. 6 using a second resin dip and UV curing for surface finishing, while “SPRAY” indicates that after the first resin dip and curing, the articles were finished instead by other means, applying two successive light coats of spray enamel, such as that sold under the trademark KRYLON by Krylon Products Group, following the manufacturer's directions. To make comparison of the treated samples simpler, transparent gloss was used.

TABLE 1

| Specimen | Resin | Preheat | Finish |
|---|---|---|---|
| Left half of head. | (Left untreated for reference and | | |
| | comparison) | | |
| Right half of head. | Pure UV-R | 60° C. | DIP |
| Upper left torso incl. gift. | Pure UV-R | 60° C. | SPRAY |
| Lower left torso, left arm. | Pure UV-R | 90° C. | DIP |
| Upper right torso w/top of C. | Pure UV-R | 90° C. | SPRAY |
| Lower right torso w/bottom of C. | 80-20 mix | 60° C. | DIP |
| Right arm. | 80-20 mix | 60° C. | SPRAY |
| Left leg. | 80-20 mix | 90° C. | DIP |
| Right leg. | 80-20 mix | 90° C. | SPRAY |

All eight resin processes were seen to improve specimen resistance to abrasion quite dramatically over that of the untreated material, while also giving colors a darker, richer look. No appreciable differences in these qualities appeared from one process to another.

Specimens first treated with pure SUNFLASH resin and then sprayed with clear KRYLON enamel had a somewhat better, more uniform gloss than those first treated with the 80% SUNFLASH, 20% CASTIN′ CRAFT mixture and then sprayed. Using a second resin dip and UV cure (using the same resin) gave a superior gloss, with no apparent difference between pure SUNFLASH and the 80%-20% mixture when so used.

Specimens preheated to 90° C. had a noticeably poorer, less even gloss than those preheated only to 60° C. It is suspected that either thermal shock, some small degree of dehydration and resulting breakdown in the hardened gypsum, or both, may have been at fault. These results were used to optimize the process conditions previously set forth.

### Example 2

To evaluate the effects of treatment on conventionally cast gypsum, while conserving the remaining two articles for other use, a series of tensile test specimens, nominally identical before treatment, were prepared as follows.

A master was cut from a 1 inch by ⅛ inch (2.54 cm by 0.32 cm) basswood strip, roughly in the shape of an hourglass with central test section ⅜ inch (0.95 cm) long and ¼ inch×⅛ inch (0.64 cm by 0.32 cm) in cross section. Molds were made by pressing room temperature vulcanization silicone, such as that sold under the trademark RIO COLD MOLD by RIO GRANDE, over the master.

To form the specimens, a weighed 6.00 grams of commercial plaster of Paris (such as that sold under the trademark BASIC ELEMENTS #18231, distributed by Horizon Group, USA) were thoroughly mixed with 2.00 milliliters of distilled water dispensed from a burette. The mixture was poured into one of the molds just described, carefully distributed to eliminate voids, and then allowed to set for at least four hours before removal.

The cast gypsum test specimens were numbered, set aside to dry thoroughly, and then measured with a dial caliper. As shown in Table 2 the test section width was found consistent at 0.251±0.003 inch (0.64±0.001 cm). Due to deliberate overfilling, the thickness always exceeded 0.125 inch (0.32 cm). The specimens were then carefully hand sanded, reducing their thicknesses to 0.125±0.0005 inch (0.32±0.0.0002 cm).

Of twelve specimens originally prepared, one (#3) broke during sanding and two others (#5 and #8) were undersized as a result of excessive sanding. Those three were discarded and are not shown in Table 2.

TABLE 2
(dimensions in inches; breaking load in grams).

| Specimen | Width | Thickness | Sanded | Group | Break Ld. |
|---|---|---|---|---|---|
| 1 | .051 | .132 | .125 | B | 3533 |
| 2 | .052 | .134 | .125 | C | 5608 |
| 4 | .051 | .140 | .125 | B | 3633 |
| 6 | .051 | .128 | .125 | A | 2801 |
| 7 | .049 | .135 | .125 | C | 5720 |
| 9 | .248 | .132 | .125 | A | 3228 |
| 10 | .251 | .126 | .125 | B | 4443 |
| 11 | .251 | .128 | .125 | A | 3107 |
| 12 | .251 | .141 | .125 | C | 5198 |
| 13 | .252 | .127 | .125 | Resin | 31764 |
| 14 | .252 | .128 | .125 | Resin | 37416 |
| 15 | .254 | .126 | .125 | Resin | 20844 |

The nine remaining specimens were divided randomly into three groups A, B, and C as shown in Table 2. Those in Group A were left untreated; those in Group B were given a first resin dip according to FIG. 6 but not dipped a second time for the glossy finish, but rather followed by blotting away of liquid resin remaining on their surfaces; and those in Group C were dipped a second time for the glossy finish.

For comparison, three specimens of pure SUNFLASH resin were also prepared by pouring liquid resin into the same molds, allowing them to harden a full day in the sun, then unmolding and treating in the same way as the plaster specimens. These are shown in the last three rows of Table 2.

The specimens were then tested to failure by gripping the wide ends of the hourglass in padded jaws and applying slowly increasing tension until the central test section snapped apart. Breaking loads in grams (1 gram=0.0098 N=0.0022 lbf) are shown in the rightmost column of Table 2.

Group A, Group B, Group C, and pure-resin breaking loads were then averaged and converted to tensile strengths in pounds per square inch. Table 3 shows the results.

TABLE 3

| | A | B | C | D |
|---|---|---|---|---|
| Avg Breaking Load (gms) | 3045 | 3870 | 5509 | 30,008 |
| Tensil Strength (p.s.i) | 215.1 | 273.4 | 289.2 | 2120 |
| % increase over untreated specimens | 0 | 27.09 | 80.92 | 885 |

As can be seen from Table 3, the first resin dip improved the tensile strength of the singly-dipped specimens by an average of 27%. The surfaces of these specimens appeared rough after treatment, and the surprisingly small percentage increase in strength likely resulted from local stress concentrations at pits or cracks incompletely filled by resin. The second dip filled these openings, yielding a smooth glossy surface and a strength increase of 81% over the untreated specimens despite the fact that only about 20% of the void space in the test sections of these specimens, as estimated from the microscope image in FIG. 2B, was actually filled by resin. These results are consistent with the roughly ten-to-one ratio between the tensile strengths of untreated gypsum and pure solid resin, as measured using the final three test specimens.

Following testing, a fragment of twice-dipped (Group C) specimen #2 was sectioned and examined under an optical microscope. As shown in FIG. 2B, the four layers were clearly visible, with estimated average thicknesses of about 0.0015 inch, 0.006 inch and 0.010 inch for first layer 110 filled with resin, second layer 112 fully infiltrated by resin, and third layer 114, which is partially infiltrated by resin, respectively. These thicknesses, of course, can be expected to vary with the type of article being treated, increasing with either its size or its porosity.

### Example 3

The two remaining decorative articles were treated by the process described above, using a resin dip for finishing. They included large areas of uniform color and fine detail also in color, which color was incorporated during the original printing process.

After oven heating, one article was suspended throughout the remainder of the process from a Teflon-covered wire passed through a ring molded into its top: dipped into the resin, suspended briefly above it to let unneeded resin drip back, then, while suspended, surrounded by LED ultraviolet lamps for curing, then re-dipped and re-cured to form the finish coat. The other article was dipped in the resin using tongs, then UV-exposed on a platform formed by weaving strands of the same Teflon-covered wire forming an open mesh similar to hardware cloth.

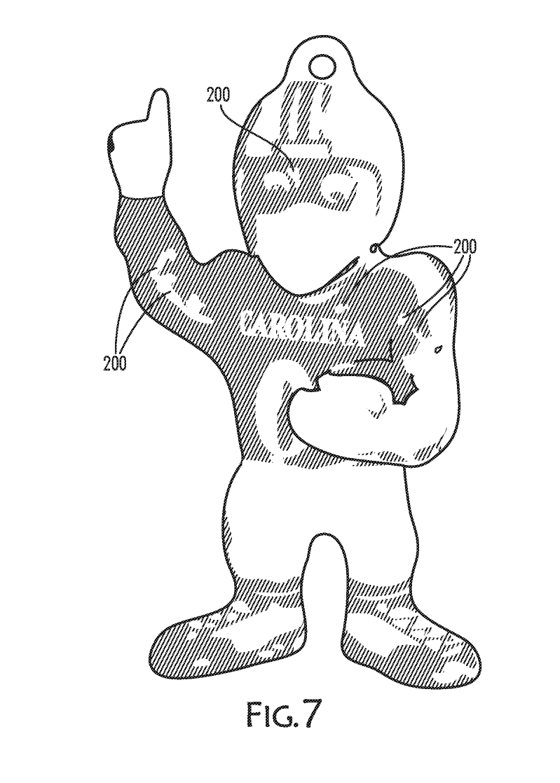

One of the articles so treated is shown in FIG. 7, which was adapted from a photograph by thresholding. Strong highlights 200 can be seen on the surface of the head, chest, and especially near the elbow of the upraised arm, indicating the achievement of a high-gloss surface on the formerly dull, almost chalky-appearing article.

As is evident from the above description to those skilled in the art, the disclosed process may be modified or adjusted while remaining within the spirit of the disclosure.

1. A process for sealing a 3-D article made of gypsum, comprising the steps of:
(a) providing a 3-D article made of gypsum;
(b) heating a polyester resin to a first temperature, said polyester resin being curable on exposure to ultraviolet light;
(c) heating the 3-D article to a second temperature higher than said first temperature;
(d) applying said polyester resin to said 3-D article while said 3-D article is still at said second temperature by spraying or dipping said 3-D article;
(e) removing excess polyester resin from said 3-D article and thereby leaving a foundation coat on said 3-D article; and
(f) curing said polyester resin with ultraviolet light.

2. The process of claim 1, wherein said second temperature is between 40° C. and 80° C.

3. The process of claim 1, wherein said second temperature is 60° C.

4. (canceled)

5. The process of claim 1, wherein said polyester resin is a mixture of straight-chain, unsaturated polyester resins that are the condensation products of propylene glycol with a blend of phthalic and maleic anhydrides, and wherein said mixture has a refractive index, and wherein said 3-D article has a refractive index, and wherein said refractive index of said cured polyester resin is adjusted to match said refractive index of said gypsum by varying the blend of phthalic and maleic anhydrides.

6. The process of claim 1, further comprising the step of applying a finishing coat to said 3-D article.

7. The process of claim 6, wherein said finishing coat is paint.

8. The process of claim 6, wherein said finishing coat is said polyester resin.

9. The process of claim 1, wherein said curing step continues until said polyester resin has no odor of solvent.

10. The process of claim 1, wherein said curing step continues until no solvent is detected by absorption spectroscopy from curing of said polyester resin.

11. The process of claim 1, wherein said ultraviolet light is ultraviolet-A light.

12. The process of claim 1, wherein said ultraviolet light has a wavelength of approximately 365 nm.

13. The process of claim 1, wherein said ultraviolet light is generated by gallium-nitride light emitting diodes.

14. The process of claim 1, wherein said polyester resin is illuminated only by yellow light-emitting diodes until said curing step.

15. A process for cosmetically coating a 3-D article, comprising the steps of:
(a) providing a 3-D article made of gypsum;
(b) providing a bath of polyester resin;
(c) heating said 3-D article to a temperature between 40° C. and 80° C.;
(d) dipping said 3-D article into a bath of said polyester resin while said 3-D article is still hot;
(e) keeping said 3-D article in said polyester resin until said article cools;
(f) removing excess polyester resin from said 3-D article and thereby leaving a foundation coat on said article;
(g) immediately curing said polyester resin on said 3-D article by exposure to ultraviolet light; and
(h) applying a finishing coat to said 3-D article after said polyester resin on said 3-D article is cured.

16. The process as recited in claim 15, wherein said polyester resin is maintained at a temperature below 40° C.

17. A 3-D article, comprising:
(a) a first layer;
(b) a second layer inside said first layer, said second layer being a three-dimensional lattice of rod-like gypsum crystals with pores filled by cured polyester resin; and
(d) a third layer inside said second layer, said third layer being a three-dimensional lattice of rod-like gypsum crystals with pores free of polyester resin.

18. The article of claim 16, wherein said cured polyester resin has a first index of refraction and said gypsum crystals have a second index of refraction and wherein said first index of refraction matches said second index of refraction.

19. The article of claim 17, wherein said first layer is made of paint or enamel.

20. The article of claim 17, wherein said first layer is cured polyester resin.
